(19) United States
(12) Patent Application Publication
(10) Pub. No.: US 2002/0140908 A1
(43) Pub. Date: Oct. 3, 2002

(54) Single-panel projection display device

(76) Inventors: Sung-Tae Kim, Seoul-city (KR); Eun-Seong Seo, Seoul-city (KR)

Correspondence Address: Robert E. Bushnell, Suite 300, 1522 K Street, N.W., Washington, DC, 20005, US

(21) Appl. No.: 10/103,139

(22) Filed: Mar. 22, 2002

(30) Foreign Application Priority Data
Mar. 28, 2001 (KR) 2001-16259

(51) Int. Cl. G03B 21/00

(52) U.S. Cl. 353/31

(57) ABSTRACT

A projection display system includes a light source for providing a white light; a light separating unit for separating the red (R), green (G) and blue (B) lights from the white light provided by the light source; a light deflecting unit for concurrently deflecting R, G and B lights without being mixed with each other and irradiating R, G and B lights toward a modulating unit; and the modulating unit for modulating R, G and B lights to form a color image.

### CLAIM OF PRIORITY

This application makes reference to, incorporates the same herein, and claims all benefits accruing under 35 U.S.C. §119 from an application for Optical Apparatus of One Panel Projection System earlier filed in the Korean Industrial Property Office on Mar. 28, 2001 and there duly assigned Serial No. 2001-16259.

### BACKGROUND OF THE INVENTION

1. Field of the Invention

The present invention relates to a projection display device, and more particularly, to a single-panel projection display device having a high optical efficiency.

2. Description of Related Art

A liquid crystal (LC) projector includes an LC panel as a modulator for modulating light from a light source to form an image. The LC panel is divided into two types including a transmissive type and a reflective type. A poly-silicon liquid crystal display is mainly used as the transmissive LC panel, and a digital micromirror device (DMD) and a liquid crystal on silicon (LCOS) device are mainly used as the reflective LC panel.

Of these, the LCOS display recently receives an attention due to a small size and a high resolution. In the LCOS display, a three-panel LC projector or a single-panel LC projector has been used to achieve a full color.

The three-panel LC projector is one which light rays emitted from a light source are divided into R (red), G (green) and B (blue) light rays by R, G and B dichroic mirrors, travel through three R, G and B liquid crystal panels, and are combined by a dichroic prism, and a color picture is projected through a projection lens in an enlarged color picture on a screen.

The single-panel LC projector is one which light rays emitted from a light source are divided into R, G, and B light rays by a color separating means, and travel through a single LC panel, and a color picture is projected through a projection lens in an enlarged color picture on a screen. The color separating means includes a color wheel, a color switch, a philips prism, or the like.

FIG. 1 is a schematic view illustrating a color wheel for use in a conventional single-panel projection system. The color wheel of FIG. 1 includes R, G and B color regions. The color wheel of FIG. 1 is rotated by a driving means (not shown) so as to separate light rays emitted from a light source such as a lamp into R, G and B light rays and to direct R, G and B light rays toward a single LC panel in sequence.

However, since the color wheel of FIG. 1 separates R, G and B light rays by R, G and B color regions and then directs R, G and B light rays toward the single LC panel in sequence, an optical efficiency is merely a maximum of ⅓. That is, just one of R, G and B light rays directs toward the LC panel, leading to an optical loss of ⅔.

### SUMMARY OF THE INVENTION

It is therefore an object of the present invention to provide a projection display device having a high optical efficiency.

It is another object of the present invention to provide a projection display device having a high operating speed.

In order to achieve the above and other objects, the preferred embodiments of the present invention provide a projection display system, including a light source for providing a white light; a light separating unit for separating R, G and B lights from the white light provided by the light source; a light deflecting unit for concurrently deflecting R, G and B lights not to be mixed with each other and irradiating R, G and B lights toward a modulating unit; and the modulating unit for modulating R, G and B lights to form a color image.

The light separating unit includes an X-cube and first and second mirrors. The X-cube includes first and second reflecting surfaces crossed with each other and the first and second mirrors are arranged parallel to the first and second reflecting surfaces, respectively. The light deflecting unit includes three polygon mirrors, the polygon mirrors are rotatable by a motor and deflecting R, G and B lights, respectively. Rotation axes of the polygon mirrors are spaced apart from each other to prevent R, G and B lights from being mixed.

The system further includes an optical path difference equalizing unit for equalizing an optical path difference between R, G and B lights and for condensing R, G and B lights onto an optical path. The optical path difference equalizing unit includes three relay lenses. The optical path difference equalizing unit is disposed between the light separating unit and the light deflecting unit. The modulating unit is a reflective liquid crystal panel.

The system further includes a fly-eyes lens for making light emitted from the light source uniform, a polarizing converting unit and a polarizing beam splitter, the polarizing converting unit for converting light to a p-wave polarized light, the polarizing beam splitter for transmitting a p-wave polarizing light and reflecting an s-wave polarized light generated from the modulating unit, and a projecting unit for enlarging the color image generated from the modulating unit and projecting the color image to a screen.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic view illustrating a color wheel for use in a conventional single-panel projection system; and

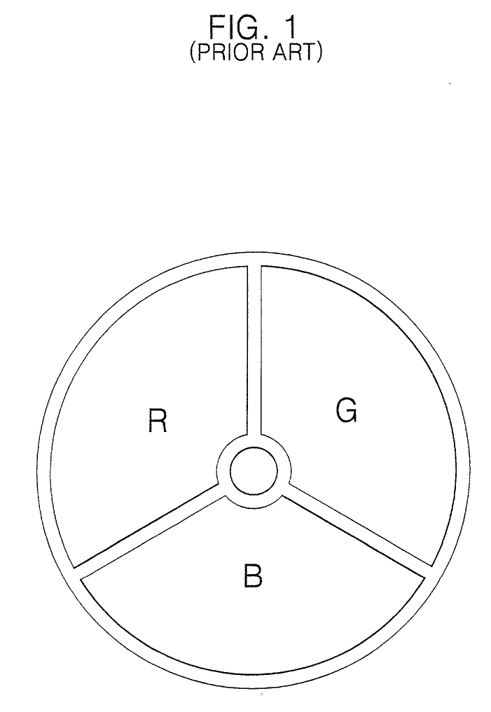

FIG. 2 is a block diagram illustrating a projection display device according to a preferred embodiment of the present invention.

### DETAILED DESCRIPTION OF PREFERRED EMBODIMENTS

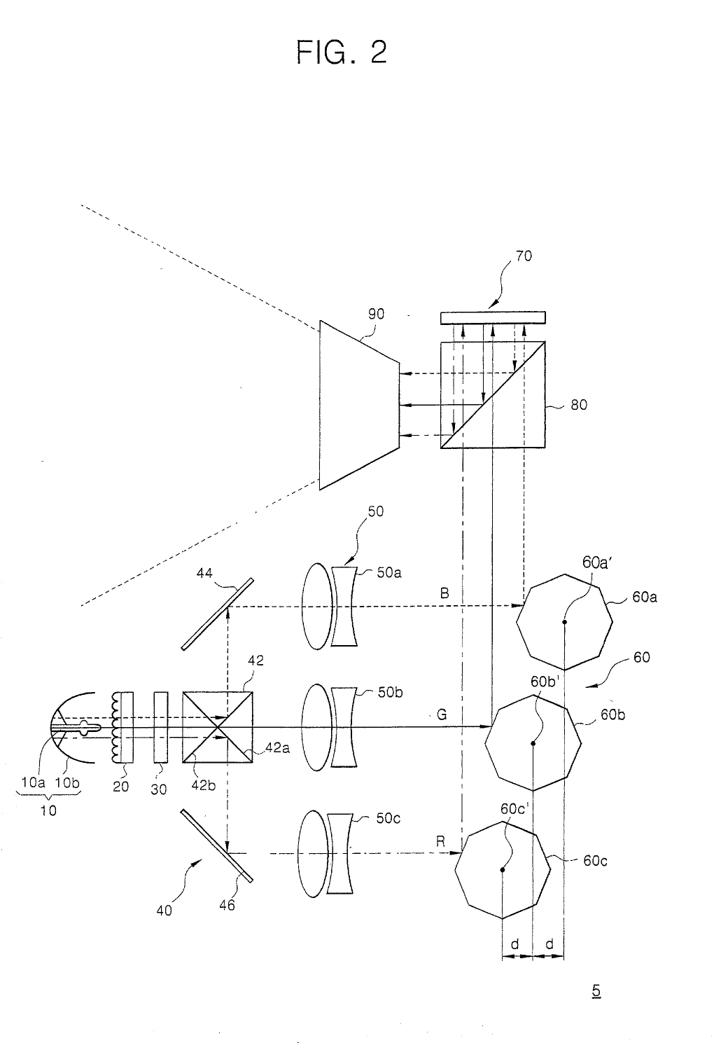

Turning now to the drawings, FIG. 2 is a block diagram illustrating a projection display device 5 according to a preferred embodiment of the present invention.

The projection display device 5 of FIG. 2 includes a light source 10, a fly-eyes lens 20, a polarization converting unit 30, a light separating unit 40, an optical path difference equalizing unit 50, a light deflecting unit 60, a modulating unit 70, a polarizing beam splitter 80, and a projecting unit 90.

The light source 10 includes a lamp 10a and a parabolic reflector 10b. Light emitted from the lamp 10a is reflected by the parabolic reflector 10b, so that parallel light directs toward the fly-eyes lens 20. The fly-eyes lens 20 is a light uniformization means which makes parallel light from the light source 10 uniform. The polarization converting unit (or polarizing conversion system) 30 is a light converting means which converts the uniformized light to a p-wave polarized light.

The light separating unit 40 separates R, G and B light rays from the p-wave polarized light and irradiates R, G and B light rays to the optical path difference equalizing unit 50. The light separating unit 40 includes an X-cube 42 and mirrors 44 and 46. The X-cube 42 includes reflecting surfaces 42a and 42b which are crossed with each other. The reflecting surface 42a reflects the R light ray and directs the R light ray toward the mirror 46, and the reflecting surface 42b reflects the B light ray and directs the B light ray toward the mirror 44. The G light ray is transmitted through the X-cube 42 “as is” (without change).

The optical path difference equalizing unit 50 includes relay lenses 50a, 50b and 50c, and equalizes an optical path difference between R, G and B light rays. Such an optical path difference results from the fact that rotation axes 60a′ to 60c′ of polygon mirrors 60a to 60c, respectively, are spaced apart from each other. That is, the rotation axis 60a′ of the polygon mirror 60a is at a distance “d” from the rotation axis 60b′ of the polygon mirror 60b, and the rotation axis 60b′ of the polygon mirror 60b is at a distance “d” from the rotation axis 60c′ of the polygon mirror 60c.

The relay lenses 50a to 50c are designed in consideration of a wavelength characteristic and an optical path of R, G and B light rays. The relay lens 50a condenses the B light ray and directs the condensed B light ray to the polygon mirror 60a. The relay lens 50b condenses the G light ray and directs the condensed G light ray to the polygon mirror 60b. The relay lens 50c condenses the R light ray and directs the condensed R light ray to the polygon mirror 60c.

Meanwhile, the optical path difference equalizing unit 50 can be disposed at any location on an optical axis, and is preferably disposed between the light separating unit 40 and the light deflecting unit 60.

The light deflecting unit 60 includes the polygon mirrors 60a to 60c. The rotation axes 60a′ to 60c′ of the polygon mirrors 60a to 60c are spaced apart from each other so as to prevent R, G and B light rays from being mixed.

By rotating the polygon mirrors 60a to 60c using a motor (not shown), the polygon mirrors 60a to 60c deflect R, G and B light rays so that R, G and B light rays can be irradiated toward the modulating unit 70, respectively.

Since the R, G and B light rays irradiated toward the modulating unit 70 are the p-wave polarized lights, the R, G and B light rays transmit through the polarizing beam splitter 80 and enter the modulating unit 70.

The modulating unit 70 is preferably a reflective liquid crystal (LC) panel. Pixels of the reflective LC panel 70 which are turned on, modulate the incident light thereto to s-wave polarized lights, and pixels of the reflective LC panel 70 which are turned off, modulate the incident light thereto to p-wave polarized lights.

The polarizing beam splitter 80 reflects the s-wave polarized lights and transmits the p-wave polarized lights. The projecting unit 90 enlarges and projects the s-wave polarized lights, thereby forming a color image on a screen. That is, the polarizing beam splitter 80 irradiates only the lights selected to form a color image to a screen (not shown) through the projecting unit 90.

Operation of the projection display system is described below.

Parallel light rays emitted from the light source 10 become uniform by the fly-eyes lens 20. The uniformized light rays (light rays that are made uniform) are converted to p-wave polarized lights by the polarization converting unit 30. The p-wave polarized lights are separated into R, G and B light rays by the light separating unit 40 and then direct toward the optical path difference equalizing unit 50. The optical path difference equalizing unit 50 equalizes an optical path difference between R, G and B light rays. R, G and B light rays are deflected by the light deflecting unit 60 and are irradiated to the modulating unit 70.

The modulating unit 70 modulates the incident light thereto. The polarizing beam splitter 80 irradiates only the selected light to a screen (not shown) through the projection unit 90, thereby forming a color image.

Meanwhile, the polarization converting unit 30 can be designed to convert the uniformized light from the light source 10 to an s-wave polarized light. In this case, the polarizing beam splitter 80 is designed to transmit the s-wave polarized light and reflect the p-wave polarized light, and the LC panel 70 is designed such that pixels which are turned on modulate the incident light thereto to p-wave polarized lights, and pixels which are turned off modulate the incident light thereto to s-wave polarized lights.

As described herein before, the projection display system according to the present invention irradiates R, G and B light rays to the LC panel concurrently and thus significantly improves the optical efficiency. Also, R, G and B light rays are concurrently irradiated to the LC panel, and therefore a response speed of the LC panel can be significantly improved, leading to a high operating speed.

While the invention has been particularly shown and described with reference to the preferred embodiments thereof, it will be understood by those skilled in the art that the foregoing and other changes in form and details may be made therein without departing from the spirit and scope of the invention.

What is claimed is:

1. A projection display apparatus, comprising:
a light source for providing a white light;
a light separating unit for separating red, green and blue lights from the white light provided by said light source;
a light deflecting unit for concurrently deflecting red, green and blue lights while not being mixed with each other and irradiating the red, green and blue lights toward a modulating unit; and
said modulating unit for modulating red, green and blue lights to form a color image.

2. The apparatus of claim 1, further comprised of said light separating unit including an X-cube and first and second mirrors, said X-cube including first and second reflecting surfaces crossed with each other, said first and second mirrors arranged parallel to said first and second reflecting surfaces, respectively.

3. The apparatus of claim 1, further comprised of said light deflecting unit including three polygon mirrors, said three polygon mirrors rotatable by a motor and deflecting red, green and blue lights, respectively.

4. The apparatus of claim 3, further comprised of the rotation axes of said polygon mirrors being spaced apart from each other to prevent red, green and blue lights from being mixed.

5. The apparatus of claim 1, further comprising an optical path difference equalizing unit for equalizing an optical path difference between red, green and blue lights and for condensing red, green and blue lights onto an optical path.

6. The apparatus of claim 5, further comprised of said optical path difference equalizing unit including three relay lenses.

7. The apparatus of claim 5, further comprised of said optical path difference equalizing unit being disposed between said light separating unit and said light deflecting unit.

8. The apparatus of claim 1, further comprised of said modulating unit being a reflective liquid crystal panel.

9. The apparatus of claim 1, further comprising a fly-eyes lens for making light emitted from said light source uniform.

10. The apparatus of claim 1, further comprising:
a polarizing converting unit for converting the light from said light source to a p-wave polarized light; and
a polarizing beam splitter for transmitting a p-wave polarizing light and reflecting an s-wave polarized light generated from said modulating unit.

11. The apparatus of claim 1, further comprising:
a polarizing converting unit for converting the light from said light source to an s-wave polarized light; and
a polarizing beam splitter for transmitting an s-wave polarizing light and reflecting a p-wave polarized light generated from said modulating unit.

12. The apparatus of claim 1, further comprising a projecting unit for enlarging the color image generated from said modulating unit and projecting the color image to a screen.

13. An apparatus, comprising:
a light separating unit for separating a light into a plurality of colors including a first color light, second color light, and third color light;
a light deflecting unit for concurrently deflecting the first color light, second color light and third color light while not being mixed with each other and irradiating the first color light, second color light and third color light toward a modulating unit; and
said modulating unit for modulating the first color light, second color light and third color light to form a color image.

14. The apparatus of claim 13, further comprised of said light separating unit including an X-cube and first and second mirrors, the X-cube including first and second reflecting surfaces crossed with each other, said first and second mirrors arranged parallel to said first and second reflecting surfaces, respectively.

15. The apparatus of claim 14, further comprised of said light deflecting unit including three polygon mirrors rotating and deflecting the first color light, second color light and third color light, respectively.

16. The apparatus of claim 15, further comprised of the rotation axes of said polygon mirrors being spaced apart from each other to prevent the first color light, second color light and third color light from being mixed.

17. A projection display apparatus, comprising:
a light source for providing a white light;
a fly-eyes lens for making the light emitted from said light source uniform;
a polarizing converting unit for converting the uniform light from said fly-eyes lens to any one of a p-wave polarized light and an s-wave polarized light;
a light separating unit for separating red, green and blue lights from the white light provided by said light source through said polarizing converting unit, said light separating unit comprising an X-cube and first and second mirrors, said X-cube including first and second reflecting surfaces crossed with each other, said first and second mirrors arranged parallel to said first and second reflecting surfaces, respectively;
an optical path difference equalizing unit for equalizing an optical path difference between red, green and blue lights and for condensing red, green and blue lights onto an optical path from said light separating unit, said optical path difference equalizing unit including three relay lenses;
a light deflecting unit for concurrently deflecting red, green and blue lights from said optical path difference equalizing unit while not being mixed with each other and irradiating the red, green and blue lights toward a modulating unit, said light deflecting unit including three polygon mirrors, said three polygon mirrors rotatable by a motor and deflecting red, green and blue lights, respectively, the rotation axes of said polygon mirrors being spaced apart from each other to prevent red, green and blue lights from being mixed;
said modulating unit for modulating red, green and blue lights to form a color image;
a polarizing beam splitter for transmitting a p-wave polarizing light and reflecting an s-wave polarized light generated from said modulating unit when the p-wave polarized light is converted from said polarizing converting unit and transmitting an s-wave polarizing light and reflecting a p-wave polarized light generated from said modulating unit when the s-wave polarized light is converted from said polarizing converting unit; and
a projecting unit for enlarging the color image generated from said modulating unit and projecting the color image to a screen.

18. The apparatus of claim 17, further comprised of said modulating unit being a liquid crystal panel.

19. The apparatus of claim 17, further comprised of said modulating unit being a reflective liquid crystal panel.

20. The apparatus of claim 19, further comprised of said X-cube including said first reflecting surface reflecting and directing the red light toward said first mirror, said second reflecting surface reflecting and directing the blue light toward said second mirror, and the green light passing through said X-cube without change toward one of said three polygon mirrors of said light deflecting unit.
